(19) United States
(12) Patent Application Publication
(10) Pub. No.: US 2006/0277581 A1
(43) Pub. Date: Dec. 7, 2006

(54) Local entity and a method for providing media streams

(76) Inventors: Avraham Eliyahu, Holon (IL); Yariv Reches, Ramat Gan (IL); Enbar Goldberg, Katzerin (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/548,921

(22) PCT Filed: Mar. 7, 2004
(86) PCT No.: PCT/IL04/00225

§ 371 Date: Aug. 23, 2006

Related U.S. Application Data
(60) Provisional application No. 60/452,751, filed on Mar. 10, 2003.

(51) Int. Cl. H04N 7/173

(52) U.S. Cl. 725/88; 725/102; 725/94

(57) ABSTRACT

A method for providing media streams from a local entity to multiple end users devices, the method includes:(i) receiving, at a local entity, multiple input media streams; (ii) processing a first media stream to facilitate trick play modes of said first media stream; and (iii) transmitting, to the multiple end user devices, multiple groups of media streams, wherein at least one group of media streams comprises a trick play mode media stream. A local entity that includes: (i) a fetching unit adapted to receive multiple input media streams; (ii) a processor for processing a first media stream to facilitate trick play modes of said first media stream; and (iii) a transmitter, for transmitting to the multiple end user devices multiple groups of media streams, wherein at least one group of media streams comprises a trick play mode media stream.

### FIELD OF THE INVENTION

The invention relates to a local entity and methods for providing media streams such as trick modes and live media streams and especially to a domestic device for providing multiple media streams to multiple end user devices.

### BACKGROUND

Video Cassette Recorders allow an end user to record an audio-visual program. When reviewing the recorded program the viewer may perform various operations such as fast forward (FF), fast reverse (REW), play (PLAY), slow motion (SM), slow reverse and pause (PAUSE).

Video on demand (VOD) systems are based upon a provision of programs to viewers over communication networks such as Hybrid Fiber Coax (HFC) networks or satellite networks. VOD providers are requested to allow end users to implement trick modes such as fast-forward, rewind and the like. Due to various control, bandwidth and additional constraints VOD do not really perform FF, REW but display a subset of frames out of the program to emulate a FF and REW mode.

End users may also purchase a Personal Video Recorder (PVR) device that allows them to store a program in MPEG format, thus defining a stored program. Each PVR is connected to a single set top box, receives input from the set top box and records a program to which the set top box is tuned.

MPEG defines various methods for compressing and transmitting audio-visual information according to predefined timing schemes that allow displaying audio visual content embedded within media streams. Raw video streams are provided to an MPEG encoder. An array of 8×8 pixels are DCT transformed to a block of 8×8 DCT coefficient blocks. The DCT coefficient blocks are assembled to macroblocks. The macroblocks are assembled to slices, that represent a horizontal strip of a picture. The strips are combined to make a picture. Each picture has a header. The picture header includes a picture type information, indicating whether the picture is I-frame, P-frame or B-frame. Pictures are arranged at Group of Pictures (GOPs). A sequence of GOPS forms a video elementary stream. Video and audio elementary streams may be multiplexed to provide a transport stream or a program stream. In Transport streams, the elementary streams are packetized to PES packets. Each PES packet includes a header that includes a stream ID and timing information. The PES header also includes timing information such as PTS and DTS that define when the pictures are to be available to a viewer and when pictures are to be provided to a decoder, prior to said presentation

I-frames are independent in the sense that they include the entire information that is required for displaying a picture. A P-frame is decoded in response to information embedded within a previous frame, while a B-frames is decoded in response to information embedded within both a preceding and succeeding frame.

U.S. Pat. No. 6,065,050 of DeMoney suggests a system and method for indexing between various video streams that include trick play streams and normal play media streams in a video delivery system. These various streams were encoded in accordance to different presentation rates. The system generates index look up tables between the normal play media stream and the trick play streams. The table enables indexing between the streams by utilizing a normal play time standard, and associating normal play time values to offsets within the corresponding video streams. The normal play time standard is driven from the timing information of the normal play media stream. In response to a user instruction to PLAY, FF or REW the video stream, the system switches between normal play media stream and the corresponding trick play streams at predefined points that share the same normal play time value. The predefined points are stored at the lookup table. U.S. Pat. No. 6,065,050 of DeMoney is incorporated herein by reference.

There is need to provide a system and method for allowing a service provider to provide FF, REW, PAUSE, SM services to an end-user, as well as live media streams. Thus an end user that is coupled to the service provider's facilities may perform various operations such as fast forward (FF), fast reverse (REW) and play (PLAY) and may also receive live streams.

U.S. Pat. No. 6,115,532 of Saeki titled “Digital VCR with trick play image control” describes a digital video cassette recorder that operates by the selection of predetermined replay speeds and the allocation of specific locations within each track from which data may be reproduced. These specific track locations are utilized during recording to place advance television image data for reproduction during trick play operation. The trick play image data is also reproduced during normal playback but may not be utilized. The specific track locations are selected to facilitate trick play operation at a plurality of speeds in both forward and reverse directions. Since the advanced television signal comprises a plurality of predicted frames, transition from trick play to normal speed replay requires a control function which is responsive to the reproduction, at normal replay speed, of an inter frame coded frame. Various methods of reproduced image transition are used for selecting both to and from trick play reproduction.

U.S. Pat. No. 6,222,981 of Rijckaert titled “Recording of trick play signals on a record carrier” describes a format for the recording of trick play signals in which trick play segments, having sync blocks of information of a trick play signal, are recorded in groups of p successive tracks. At least first and second trick play signals are recorded on the record carrier. The first trick play signal is meant for reproduction in a reproduction apparatus at a reproduction speed n.sub.1 time the recording speed with which the trick play signals are recorded on the record carrier. The second trick play signal is meant for reproduction in the reproduction apparatus at a reproduction speed n.sub.2 times the recording speed. Both trick play signals are recorded such that upon reproduction at the speed n.sub.1 times the recording speed, m.sub.1 sync blocks of information of the first trick play signal and m.sub. 1 sync blocks of the second trick play signal are read from the record carrier during one revolution of the head drum in the reproduction apparatus.

U.S. Pat. No. 6,389,218 of Gordon, et al. titled “Method and apparatus for simultaneously producing compressed play and trick play bitstreams from a video frame sequence” describes an “all-in-one” encoder that simultaneously produces an MPEG-2 compliant fast forward, fast reverse and play bitstreams from a sequence of video frames, e.g., 601-format video. The encoder subsamples the video sequence, extracting a plurality of frames from the video sequence and buffering the subsampled frames. Simultaneous with the subsampling and buffering, the source frames are encoded within a real-time encoder, e.g., an MPEG-2 encoder. The buffered frames are recalled from the buffer and coupled to a second real-time encoder. The second encoder forms both the fast forward and fast reverse bitstreams using a time multiplexing technique wherein a group of pictures (GOP) for the fast forward stream can be formed, followed by the compression of the same GOP having the frames organized in reverse order. As such, the compressed GOPs are represented by the fast forward and fast reverse bitstreams. The play, fast forward, and fast reverse bitstreams for each GOP are organized into a file and stored on the mass storage device (e.g., disk drive array) of the file server.

The following patents and patents application provide an overview of the state of the art methods and devices for providing trick play. Some devices include tape recorders. All the mentioned below patents and patent applications are incorporated herein by reference.

U.S. Pat. No. 6,445,738 of Zdepski et al. titled “System and method for creating trick play video streams from a compressed normal play video bitstream” describes a system and method for generating trick play video streams, such as fast forward and fast reverse video streams, from an MPEG compressed normal play bitstream. The system receives a compressed normal play bitstream and filters the bitstream by extracting and saving only portions of the bitstream. The system preferably extracts I-frames and sequence headers, including all weighting matrices, from the MPEG bitstream and stores this information in a new file. The system then assembles or collates the filtered data into the proper order to generate a single assembled bitstream. The system also ensures that the weighting matrixes properly correspond to the respective I-frames. This produces a bitstream comprised of a plurality of sequence headers and I-frames. This assembled bitstream is MPEG-2 decoded to produce a new video sequence which comprises only one out of every X pictures of the original, uncompressed normal play bitstream. This output picture stream is then re-encoded with respective MPEG parameters desired for the trickplay stream, thus producing a trickplay stream that is a valid MPEG encoded stream but which includes only one of every X frames. The present invention thus generates compressed trick play video streams which require reduced storage and reduced data transfer bandwidth requirements.

U.S. Pat. No. 6,621,979 of Eerenberg et al. titled “Trick play signal generation for a digital video recorder using retrieved intra-encoded pictures and generated inter-encoded pictures” describes a trick play information stream is generated from a normal play information stream, so that they can be recorded together as a composite information stream on the record carrier, such that upon reproduction in a trick play reproduction mode, an information signal of sufficient quality, e.g., as regards visibility, can be obtained. GOPs are generated, each GOP including an I-frame retrieved from the original normal play information stream, and one or more so-called ‘empty P frames’. Another aspect is the requirement of generating GOPs for the trick play information stream that have a constant bitcost per GOP. Again, another aspect lies in the retrieval of the T-frame for the trick play information stream from the normal play information. More specifically, an I-frame is generated by retrieving, from an I-frame included in the normal play information, the DC coefficient of the I-frame and a number of AC coefficients from that I frame, and generating the I-frame for the trick play information stream therefrom. More specifically, the number of AC coefficients for an I-frame of the trick play information signal depends on the difference between the DC coefficients of two subsequent I-frames in the normal play information from which the I-frame to be generated and the just previously generated I-frame for the trick play information signal have been derived.

U.S. Pat. No. 6,658,056 of Duruoz, et al. titled “Digital video decoding, buffering and frame-rate converting method and apparatus” describes a digital video presentation system is provided with a decoder to decode full frame MPEG-2 video by a single method that applies regardless of buffer memory and frame rate conversion considerations. A display control module handles frame rate and field sequence in response to host configuration, particularly buffer memory size and display type (NTSC or PAL), to host trick play command signals, and to information in the received bitstream. Pictures are decoded as buffer memory for the decoded pictures becomes available, and picture display attributes are assigned and stored in a table, one string for each decoded picture. Field display logic is informed of the to memory address of the next field to be displayed along with the attributes needed for affecting proper field display sequence, and flagging whether the memory is to be freed for use by the decoder as the field is being displayed and whether the decoder is to decode the next picture as the field is being displayed. Where memory is small, opposite field data can be output. Field sequence order is provided for output buffers in the range of from 0.53 to 0.67 frames in size, or a full frame in size. Buffer memory is optimized by maintaining tables of off-set variables and accessing a fixed table of memory pointers as fields of data are being displayed. The offset data tables are identified to the display logic, which uses the data in the specified offset table to address rows of memory in which the consecutive rows of particular field to be displayed are stored. The decoder loads offset values into the offset tables as pictures are being decoded and rows of blocks of the picture are stored as memory becomes free.

U.S. patent application publication number 20030231867 of Matthijs et al. titled “programmable video recorder having flexiable trick play” describes a computing system connected to storage medium and one or more rendering devices identifies and processes only selected frames of data that are stored on the storage medium, thereby reducing the resources and bandwidth is required to process and transmit the data to the rendering device(s) at a desired playback. The computing system has various modes for selecting the frames to be processed and transmitted. In one mode, all frames are selected. In another mode, only the key frames are selected. In yet other modes, only certain key frames are selected. Upon selecting the frames to be transmitted to the rendering device(s), the time stamps assigned to the selected frames are scaled so that the selected frames will be displayed for an appropriate duration of time that corresponds with the desired playback rate.

U.S. Pat. No. 6,396,999 of Van Gestel titled “Recording device for recording a digital information signal on a record carrier” describes a recording device writes a multiple video stream and a corresponding trick-mode data signal on a record carrier. The recording device includes a selector for selecting at least two video streams from at least one multiple video stream, a trick-mode data generating unit for generating a trick-mode data signal, and a write unit for writing the selected video streams and the trick-mode data signal in a normal-play area or in a trick-play area on the record carrier. The trick-mode data generating unit is adapted to generate, for all the selected video streams, a corresponding trick-mode signal and to combine the corresponding trick-mode signals to a trick-mode data signal. The trick-mode data signal represents a mosaic image that can be displayed by a reproducing device.

U.S. Pat. No. 6,434,748 of Shen, et al titled “Method and apparatus for providing VCR-like “trick mode” functions for viewing distributed video data” describes an apparatus for providing VCR-like “trick mode” functions, such as pause, fast-forward, and rewind, in a distributed, video-on-demand program environment in which segments of a program are repeatedly transmitted. Trick modes are supported by locally altering the viewing speed for each user who requests such functions, without affecting the operation of the central data source in any way. Thus, a virtual unlimited number of viewers are able to enjoy random access to video programming, including virtually continuous trick mode functionality. This is accomplished in a manner that is operable with existing telephone and cable distribution infrastructure.

U.S. Pat. No. 6,480,664 of Ting, et al. titled “Trick mode VTR which generates trick play data from a stream of images containing intra-pictures and predictive pictures and selects specific DCT coefficients for intra-pictures” describes a tape formatting, tracking and trick mode data generation are disclosed for providing trick modes for compressed video stored on a video tape. The tape is formatted so that trick mode data is recorded at normal speed within certain areas delineated by predetermined boundaries that are within a maintainable range of a predetermined ideal scan path of the heads. These boundaries are oblique to the normal speed tracks and define trick mode data areas in which trick mode data may be recorded. To facilitate tracking, sync words and trick mode identification codes are interleaved within the trick mode data areas. During tracking, the heads reproduce the sync words and identification codes, and the identification codes that match the currently utilized trick mode are counted. The count during a current interval is compared to a count during a previous interval or a threshold to determine if the heads have locked onto the ideal scan path or deviated therefrom. Trick mode data is generated by replicating a limited portion of the compressed video data of selected pictures, which trick mode data can be independently reproduced, decoded and presented during trick mode playback.

U.S. Pat. No. 6,628,890 of Yamamoto et al. titled “a digital recording/reproduction apparatus” describes an apparatus for recording/reproducing image data according to MPEG2 system is provided which obtains I picture data reliably and performs trick playback smoothly. In the apparatus, a PES packet including an I picture is detected from video coded data which is recorded on a recording medium 30 by an I picture detection unit 5, an index file of the number of bytes from the start of recording or packet length and the like is created for the PES packet including the I picture data by a index file creation block 7, and the index file is recorded on an A/V-HDD 1 (10). In the trick playback process, a navigation control block 22 obtains the index file, and then obtains the I picture data from the PES packet on the basis of the index file, thereby to perform the trick playback smoothly.

U.S. patent application publication number 2004001693 of Cavallerano, et al. titled “Method and apparatus for trick-mode support of audio/video/data streams with conditional access” describes a method for trick-mode play of an encrypted transport stream containing audio/video/data information comprising: extracting and decrypting data used as local metadata for programs in the encrypted transport stream; creating trick-mode pointers from the metadata; and storing the trick-mode pointers and the encrypted transport stream on a storage medium.

Typically, each home includes multiple end user devices such as set top boxes. PCT patent application WO02/089479 titled “Home network system” of Davis et al. describes a home network system capable of receiving multiple media streams, storing at least some of the media streams and providing them to multiple set top boxes.

There is a need to provide a system and method for distributing multiple media streams, including trick mode streams, to multiple end-users over a local network, such as a domestic local network.

### SUMMARY OF THE INVENTION

The invention provides a method for providing media streams,

The invention provides a method for providing media streams from a local entity to multiple end users devices, the method includes the stages of: (i) receiving, at a local entity, multiple input media streams; (ii) processing a first media stream to facilitate trick play modes of said first media stream; and (iii) transmitting, to the multiple end user devices, multiple groups of media streams, wherein at least one group of media streams comprises a trick play mode media stream.

According to various embodiments of the invention the method facilitates storing and even trick play mode processing of conditional access media streams.

According to an embodiment of the invention a trick play mode media stream that originated from an input media stream have the same identification information.

According to an embodiment of the invention the method further includes a stage of determining a cost of reception of a conditional access media stream. The cost may be responsive to a reception of the conditional access media stream by more than a single end user device.

According to various embodiments of the invention a single carrier frequency is allocated for conveying multiple trick play mode media streams. Thus multiple end user devices can be associated with a single carrier frequency. This is not necessarily so and each end user device can be associated with a single carrier frequency.

According to an embodiment of the invention the stage of processing a media stream include storing meta-data required for generating at least one trick play mode media stream.

According to another embodiment of the invention the stage of processing includes generating and storing at least one first trick play mode media stream.

The method and a local entity are conveniently adapted to store and provide conditional access media streams and even to trick play mode process them. The method may include a stage of determining whether to store a received conditional access media stream. Preferably, the determination is responsive to requests to store another media stream, and may originate from an end user device.

According to an embodiment of the invention the method further includes a stage of receiving multiple conditional access media stream being provided at a predefined schedule. The predefined schedule is not necessarily responsive to end user requests to receive a media stream.

### BRIEF DESCRIPTION OF THE DRAWINGS

Further features and advantages of the invention will be apparent from the description below.

In order to understand the invention and to see how it may be carried out in practice, a preferred embodiment will now be described, by way of non-limiting example only, with reference to the accompanying drawings, in which:

FIGS. 1A-1B illustrate a local device 100 connected over a local network to multiple end user devices such as set top boxes 400, according to various embodiments of the invention;

FIG. 2 illustrates various components of local device 100 and of a single set top box 400, in accordance to an embodiment of the invention;

FIGS. 3A and 3B illustrate various components local device 100, in accordance to various embodiments of the invention;

FIG. 4 illustrates various set top box software components, in accordance to an embodiment of the invention;

FIGS. 5A-5C illustrate various frequency ranges allocated for conveying programs, in accordance to various embodiment of the invention;

FIG. 6 illustrates three carrier frequencies and multiple programs and trick play mode programs that are conveyed over said carrier frequencies, according to an aspect of the invention;

FIG. 7 illustrates in further detail various components of local entity 100, according to an aspect of the invention; and

FIG. 8 is a flow chart of a method for providing media streams, according to an embodiment of the invention.

### DETAILED DESCRIPTION OF THE DRAWINGS

The invention provides a local entity and methods for providing content to multiple end user device, and allowing trick play modes. For simplicity of explanation it is assumed that programs are received over a satellite base access network, and that a local device is connected to a satellite dish. Those of skill in the art will appreciate that the programs can be provided over various wireless and wire networks, including hybrid fiber cable (HFC) access networks as well as various terrestrial networks.

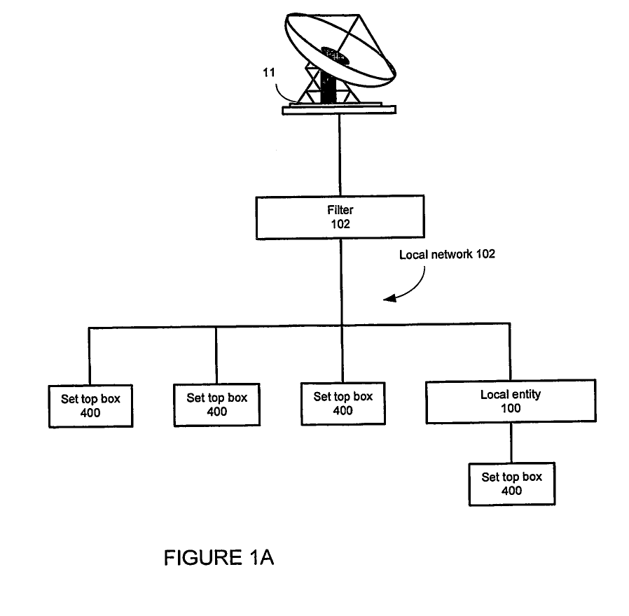

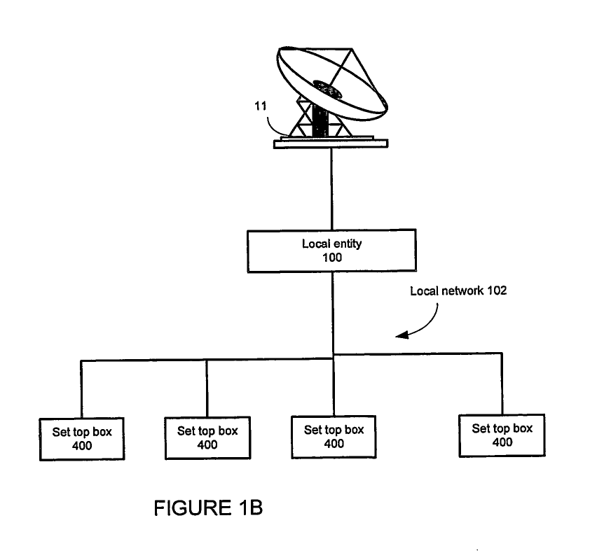

FIG. 1A illustrates a satellite dish 11 that receives multiple input programs and provides them to a local entity 100 via filter 102. The local entity sends programs signals, via local network 103, to end user devices such as set top boxes 400. Filter 102 prevents said signals, and especially trick play mode programs, from being received by satellite dish 11. The filter 102 can allow the provision of certain signals, such as a return channel signals. These latter signals can be DISEqC signals, but this is not necessarily so.

The local network 103 can include wired communication links, but may also include wireless links. It is noted that many prior art devices and methods are able of transmitting large amount of information within a limited area. These may include wide band wireless short-range transmission standards. It is noted that the invention may utilize the cables that are utilized for distributing media signals from satellite dish 11 to multiple set top boxes 400.

FIG. 1B illustrates a slightly different configuration in which the programs are provided to local entity 100 and from the local entity over a local network 103 to the multiple set top boxes 400.

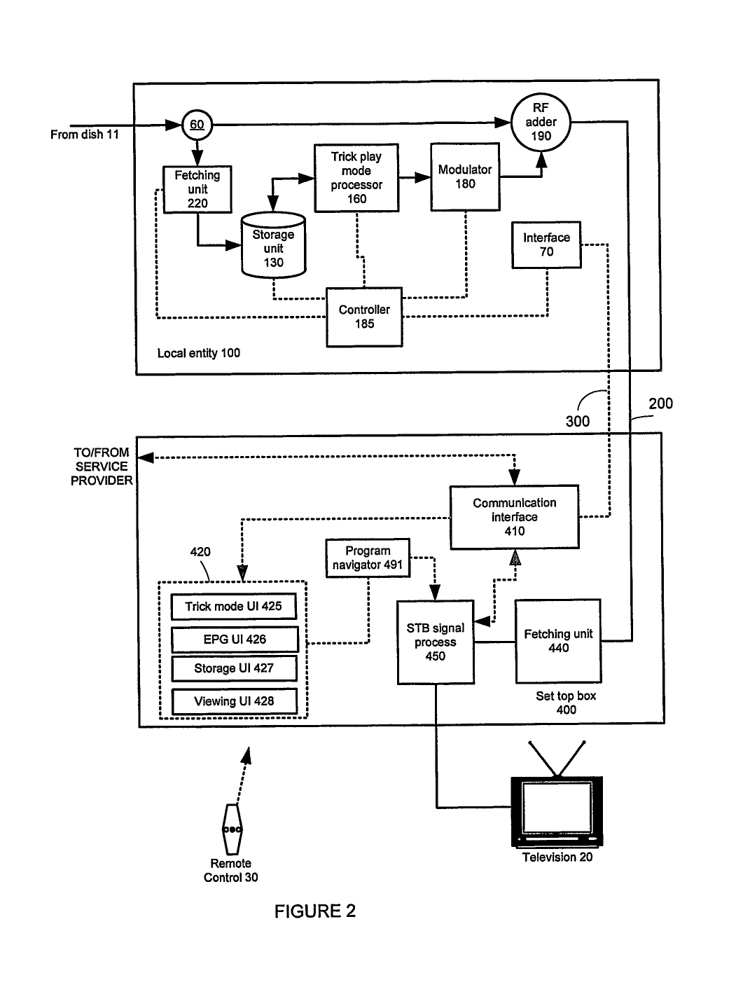

FIG. 2 illustrates a local entity 100 that is connected over a local network 103 (illustrated by an RF conveying link 300 as well as an additional communication/control link 200) to a set top box 400. It is noted that these that at least one link can be wireless and that the set top box 400 and local entity 100 can be integrated.

For simplicity of explanation it is assumes that the local entity 100 receives from satellite dish DVB and MPEG compliant Transport Streams. Those of skill in the art will appreciate that the invention is not limited to signals that comply to these standards. The received signals may include audio-visual content but also includes data. The following explanation emphasizes the processing of the media streams.

The local entity 100 and the set top box 400 facilitate recording of programs, viewing previously recorded programs, viewing trick play mode programs, viewing conditional access programs, storing conditional access programs according to a predefined schedule and later allowing to view said conditional access programs, allow an end user to manage the stored content within the local entity 100, and the like.

The local entity 100 includes a splitter 60 and an adder 90 that define a direct path through which programs and data are passed “as is” towards an adder 90 to be outputted from the local device 100. The local entity 100 also has a trick play mode/storage path that stores and/or processes programs to provide trick play mode programs and/or time-shifted programs that are provided to the adder 90. It is noted that a program may be stored for later viewing and even for later retrieval of conditional access programs such as video on demand programs viewing. The latter path includes a fetching unit 220 capable of fetching a selected program out of a multiplex of input programs and sends the fetched program to a storage unit 130. That path also includes a trick play mode processor 160 and a modulator 180. The processor 160 is capable of generating trick play mode programs and is also capable of fetching stored programs to the modulator 180. The modulator is capable of receiving digital signals, modulate them and up-convert them to be conveyed over a RF carrier frequency. The modulator 180 can be any prior art modulator including a QAM modulator, a QPSK modulator and the like. The modulation format is usually defined by standard (including DVB-C, DVB-S, DVB-T). The modulator and even the adder 90 define transmitting means for transmitting programs over the local network towards the end users.

Modulator 180 can be DVB compliant but this is not necessarily so. A DVB compliant modulator is required to perform the following operations on received input: adaptation and randomization for energy dispersal; Reed-Solomon error correction algorithm; convolutional interleaving; inner coding; base-band shaping for modulation and modulation.

The inventor found out that a modulator that includes a phase locked loop circuit is very stable and also has an advantage in cases where the carrier frequency of the modulated signal may change from program to program.

The local entity 100 is capable of receiving a conditional access broadcast schedule and to determine which programs to store. The schedule can be determined by a service provider and usually includes a small portion of the conditional access programs available from the service provider. The controller 185 may determine which program to store in response to a profile of end users connected to the local entity, to requests from end users to view program of a certain type, to requests from end users to record “regular” programs, and to the local entity recording resources. The local entity 100 may prioritize recording programs according to end user requests.

The provision of conditional access programs such as video on demand programs is defined by the service provider. Typically, the scheduling information is transmitted in-band: it is multiplexed with audio visual streams to form transport streams. The fetching filter 220 is adapted to filter the scheduling information and to send it to the storage unit an/or to the controller 185. The controller 185 may process said information and determine which program to record. In order to prevent collisions between client's generated requests to record programs and between recording of said schedule the local entity may include fetching units 220 that are capable of fetching multiple programs/data streams simultaneously.

According to an embodiment of the invention the local entity 100 has scheduling capabilities. For example, it can be adapted to schedule the recording of a program and/or the generation of trick play mode programs in response to at least one of the following: (i) requests to record programs from end user devices, (ii) timing of provision of conditional access programs, (ii) end user profile, and the like. Each request/end-user device/program can be associated with a certain priority and the local entity 100 can resolve programming conflicts in response to this priority.

The controller 185 is adapted to receive requests/commands from end user devices 400, receive information regarding the received programs and in response to control the various components of the local entity 185. The controller 185 can determine which programs are fetched by fetching unit 200 to be stored at the storage unit 130. The controller 185 is adapted to provide trick play mode parameters (such as FF, REW, the speed of the fast forward and the like) that affect the generation of the trick play mode programs that are sent to the end user devices 400. The controller 185 is operable to schedule the recording and processing of programs as well as conditional access programs.

Each stored program includes audio-visual content as well as meta-data associated with said audio-visual content. The meta-data determines which media streams belong to the same program, what is the program identification of each program (PID), what is the carrier frequency of each program and the like. The content and format of said meta-data is usually defined in various standards such as the mentioned above MPEG and DVB SI standards.

The set top box 400 includes various hardware software and middleware components. These components include various user interface applications (collectively denoted 420) such as Trick mode application 425, Electronic Program Guide application 426, storage application 427 and viewing application 428. These applications provide an interface that can be used to receive commands/requests from the end user via various means including remote control 30. The interface can be displayed on the television 20 or other display means. The trick mode application 425, facilitates trick modes, and allows the end user to define trick mode parameters such as the speed of a fast forward or of a fast rewind operation. The Electronic Program Guide application 426 displays information about scheduled programs. It can also allow to initiate an operation associated to one of the displayed programs. The storage application 427 allows the end user to watch and manipulate content that is stored at the local entity 100. The Storage application 427 retrieves storage information from the local entity 100 and presents it, or information representative of said information, to the end user. The end user may responds to the displayed information by requesting to erase a program, to view a program and the like. The viewing application 428 allows the user to view live programs in time shift mode. A certain program can be viewed and recorded simultaneously.

In many cases software upgrades, including new and/or improved applications are sent to the set top box via the satellite dish 11 and via the local entity 100.

The end user requests/command are sent to the local device 100 via the communication interface 410 of the set top box, link 200 and the interface 70 of the local entity 100. The requests are processed by the local device 100 and especially by controller 185 that can either accepts the request or reject it. For example a request to record a program can be sent by an end user that activated the EPG application, said request is sent to the local entity 100 that in turn configures the fetching unit 220 to fetch a certain program, during a certain time frame. Using its program navigation capabilities the controller 185 may define what carrier frequency as well as the program ID and/or associated media streams PIDs of the requested program to a tuner and PID filter within the fetching entity.

The controller 185 may inform the end user, via said interfaces, control link and user interfaces that the request was approved/rejected.

Referring back to the set top box 400, it further includes a fetching unit 440 that typically resembles fetching unit 220 of the local entity 100, a STB signal processing unit 450 and a program navigator 491. The fetching unit 440 has a tuner, a de-modulator, a de-multiplexer and a PIED filter that allows to retrieve a single program that is then sent to the processing unit 450 to be processed such as to allow the display of the program on the television 20. The processing unit 450 is also capable of performing conditional access related operations (such as conditional access verification, de-scrambling, initialization of a call back to a service providers, and the like), and/or MPEG decoding.

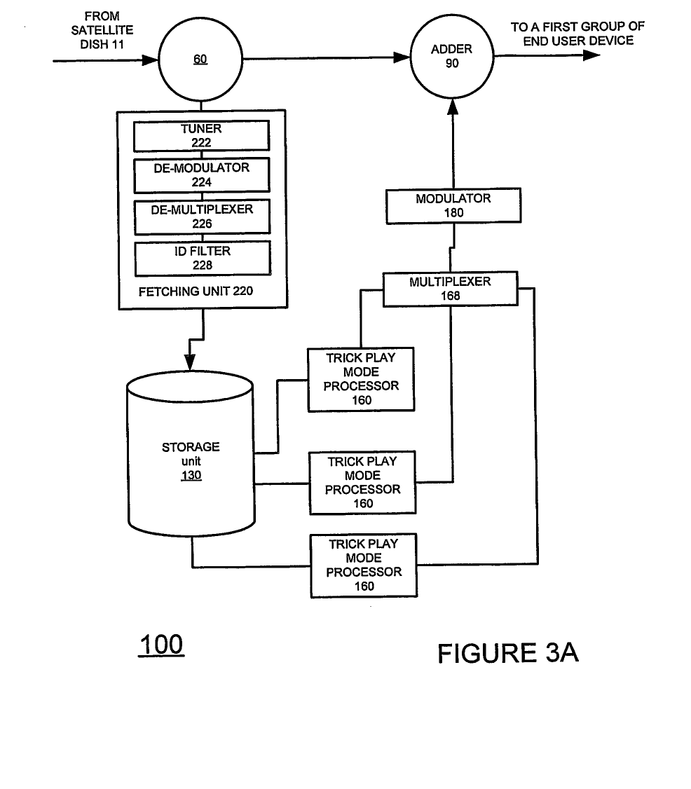

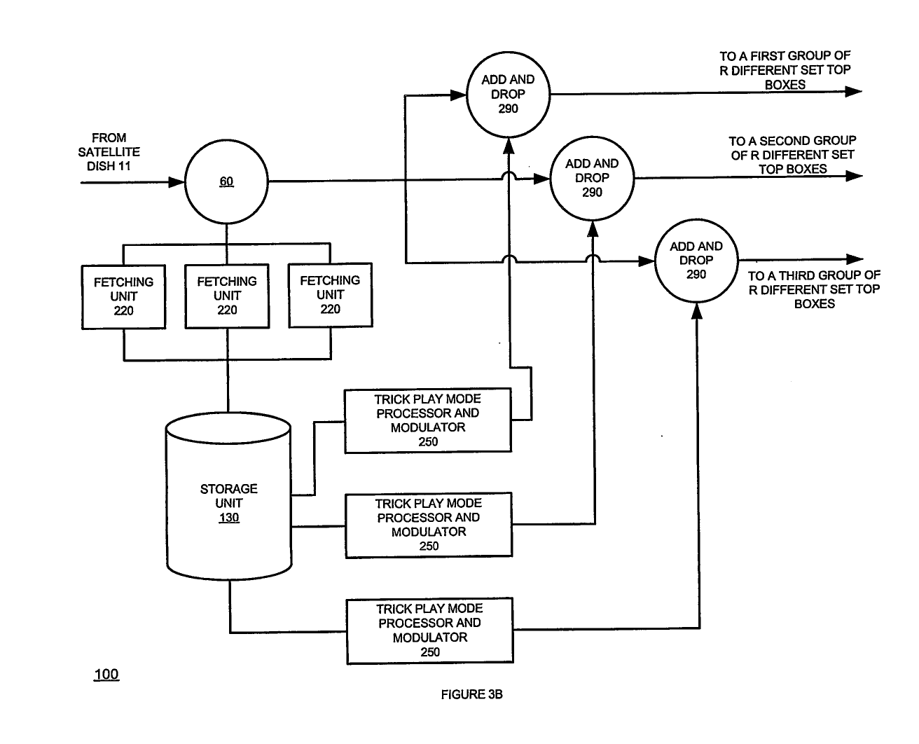

FIG. 3A illustrates various components of a local entity 100 that is capable of simultaneously providing up to R trick play mode programs simultaneously to multiple set top boxes. FIG. 3B illustrates a local entity 100 that may provide up till 3*R trick play mode programs. R is a positive integer representing an amount of trick play mode programs that can be conveyed over a single carrier frequency, or more specifically over a frequency range of 6 Mhz or 8 Mhz. R is typically ten but this is not necessarily so.

Local entity 100 of FIGS. 3A and 3B receives multiple programs from satellite dish 11 that are provided to a splitter 60. It outputs multiple groups of programs, whereas at least one of said groups may include a trick play mode program. According to various embodiments of the invention and usually in response to bandwidth constraints, the trick play mode programs can replace some of the input programs, but this is not necessarily so. For example, the trick play mode programs can be provided in addition to the input programs. Multiple trick play mode processors of FIG. 3A are connected between storage unit 130 and a multiplexer 168 that in turn is connected to modulator 180.

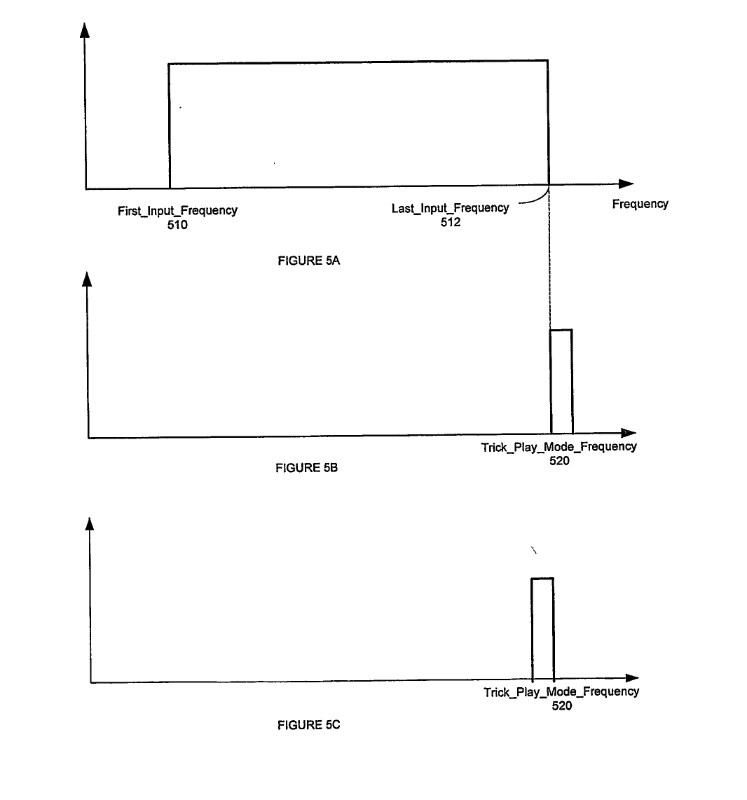

FIGS. 5A-5C illustrate exemplary spectrums of input programs as well as of trick play mode programs. FIG. 5A illustrates an exemplary range of frequencies 511 allocated for input programs, starting at First_input_frequency 510 and ending at Last_input_Frequency 512. The frequency range below the First_input_frequency is usually allocated for upstream transmission over cable networks. FIG. 5B illustrates a scenario in which at least one frequency range (Denoted Trick_Play_Mode_Frequency 520) is allocated for transmitting trick play mode programs. In typical prior art transmission systems a frequency range of about 6 Mhz is used to convey up to ten programs. Thus, range 520 can be used for transmitting multiple trick play mode programs to multiple end user devices. As illustrated by FIGS. 5A and 5B, in order to receive both trick play mode programs and input programs the end user device 400 are adapted to receive signals at both frequency ranges 511 and 520.

The inventors found that the frequency separation between input programs and trick play mode program allows maintaining the same identification information (such as PID) for trick play mode programs. This program processing process does not alter the identification information. This simplifies the tracking after programs that were displayed by the set top boxes as well as simplifies various conditional access procedures. Said procedures are usually based upon encryption keys that are associated with the program identification information.

According to another scenario, the set top boxes are adapted to receive signals within a more limited frequency range (for example only within range 511) and trick play mode programs replace input programs.

It is noted that if a trick play mode program replaces an input program the carrier frequency (or frequencies) allocated to the trick play mode program may be fixed (such as illustrated by FIG. 5C in which a fixed frequency range 520 falls within the range 511 of input programs) or may vary. According to the latter option the trick play mode program can replace the input program from which it originated.

A replacement of a single program may require de-modulating of multiple input programs that share a certain carrier frequency, de-multiplexing said multiple input streams, replacement of the program by an associated trick play mode program, multiplexing the remaining input programs and the trick play mode program and modulating said multiplex.

A replacement of multiple programs that share the same carrier frequency can also be done in the RF domain by add and drop circuitry. Said add and drop circuitry can include band stop filters as well as RF combiners. Both replacement of a single program and a replacement of multiple programs are known in the art and do not require further explanation.

It is noted that once a trick play mode program is provided to a certain end user device that device is notified about its carrier frequency as well as identification information, to assure proper reception of said trick play mode program. Thus, the end user device may be forced to alter its tuning parameters when skipping from a reception of a program to a reception of a trick play mode program. Nevertheless, according to at least one scenario the carrier frequency of the play trick mode program is the same as that of the program of the input program from which the trick play mode program originated, thus skipping between the trick play mode program and associated input program may not require re-tuning of the end user device.

FIG. 3A illustrates a local entity 100 that combines (by adder 90) input programs (from splitter 260) of a first frequency range with trick play mode programs of a second frequency range. The local entity 100 of FIG. 2B allows to replace input programs by trick play mode programs by add and drop circuitry 295. This circuitry can include RF add and drop components but may also include de-modulator, a de-multiplexing unit, a digital replacement unit, a multiplexer and a modulator.

Referring back to FIG. 3A, splitter 260 received multiple input programs from dish 11 and performs an amplitude-based splitting operation such that the input programs are provided both to adder 90 and to fetching unit 220.

Fetching unit 260 includes a tuner 222, a de-modulator 224, a de-multiplexer 226 and an PID filter 228. These components cooperate to retrieve a single program and send it to the storage unit 130. It is noted that the fetching unit 220 can be adjusted to fetch conditional access programs such as Video On Demand video, as well as fetch programs that are destined to be either merely delayed or even processed to generate trick play mode programs. The adjustment is controlled by a controller such as 185 of FIG. 2 that may select which program to store within the storage unit 130. The determination may be responsive to requests from end user devices 400, to information representative of a provision of various conditional access programs and the like.

As multiple (for example R) programs can be conveyed over a single carrier frequency, multiple (up to R) trick play mode processors 240 are coupled to a single modulator 245 that also is capable of performing a digital to analog conversion to the input it receives from processors 240. The trick play mode processors are capable of both retrieving programs from the storage unit 230 (or directly from the fetching unit 220) and generating trick play mode programs. Alternatively, the processors are capable of processing stored programs to provide meta-data (such as the location of I-frames) required for generating trick play mode programs. The processors 240 are also capable of accessing the storage unit 230 and either just fetching trick play mode programs or generating trick play mode programs. It is noted that local entity 100 may apply any of the well known methods for generating trick play mode programs, including the methods described at any of the patent and/or patent applications previously incorporated by reference.

The adder 90 adds the input programs from splitter 60 and the trick play mode programs from processors 240 and transmits a combined RF multiplex over local network 103 to set top boxes 400.

FIG. 3B illustrates a local entity 100 that has multiple fetching units 220 (each capable of retrieving up to R programs), a storage unit 230, multiple trick play mode processors and modulators 250 (each capable of retrieving up to R programs) and multiples add and drop circuitry 90. This local entity can provide up to R trick play mode programs simultaneously. It also allows a replacement of input programs by trick play mode programs.

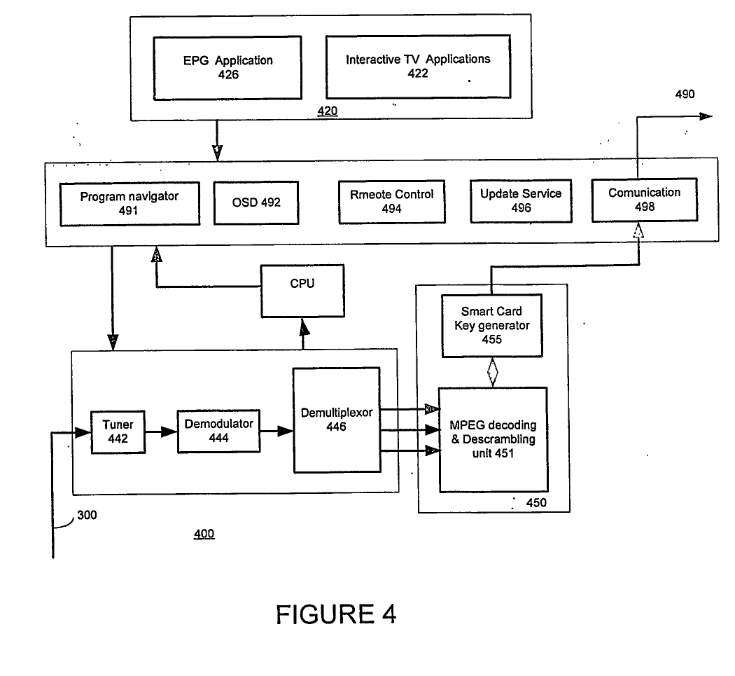

FIG. 4 illustrates various set top box 400 software components, in accordance to an embodiment of the invention.

The set top box 400 is typically managed by a middleware 490 that include various components such as program navigator 491, On Screen Display (OSD) code 492, remote control code 494, remote update code 496 (that may facilitate drivers and application upgrades) and communication code 498.

The program navigator code 491 contains and controls the DVB networks program hierarchy. Each set top box 400 may handle several DVB networks, whereas in a typical scenario each DVB network is associated with a single DVB source. Each DVB network includes several Multi Program Transport Streams (MPTS). Each MPTS may include multiple multiplexed programs. A program is usually a multiplex of a video elementary stream, audio elementary streams, conditional access (CM) information as well as a data section. These streams/section are associated with meta-data. This meta-data usually includes the PID of each section/stream, as well as the mapping between said PID and the program.

The PID are fed to the de-multiplexer 446 that can send the video and audio elementary streams of a required program to the MPEG decoding and decryption unit 451, send data to CPU 448 and sends conditional access information to an decryption entity 455 that in turn may decide whether to allow the decryption of that requested program. The decision may involve receiving an authorization from a service provider, merely notifying the service provider about the decryption operation, and may also involve storing a record of the decryption operation. The record may then be used for billing purposes. If the decryption is approved a decryption key may be sent to the MPEG decoding and decryption unit 451 that in turn processes the video and audio streams such as to enable the display of the requested program on television 20. There are various systems and method for conditional access, such as those provided by NDS of the U.K., all of which are incorporated herein by reference.

The different codes usually exchange information and especially meta-data for allowing an end user to send commands in response to information displayed on television 20 and/or in response to various buttons that appear on the remote control. The meta-data usually includes network mapping information as well as timing information (for example TDT and TOT), EPG information (such as program start time, program end time, brief description of the program and the like).

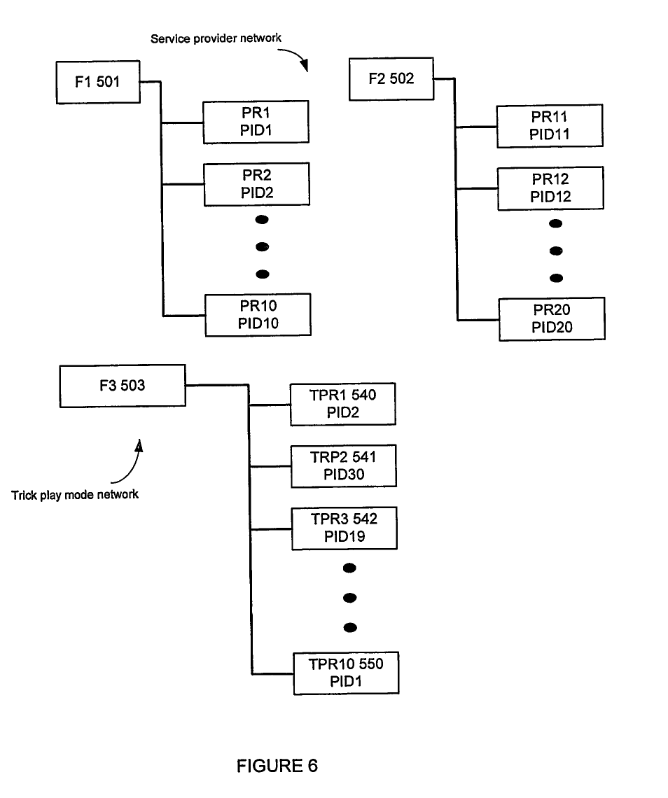

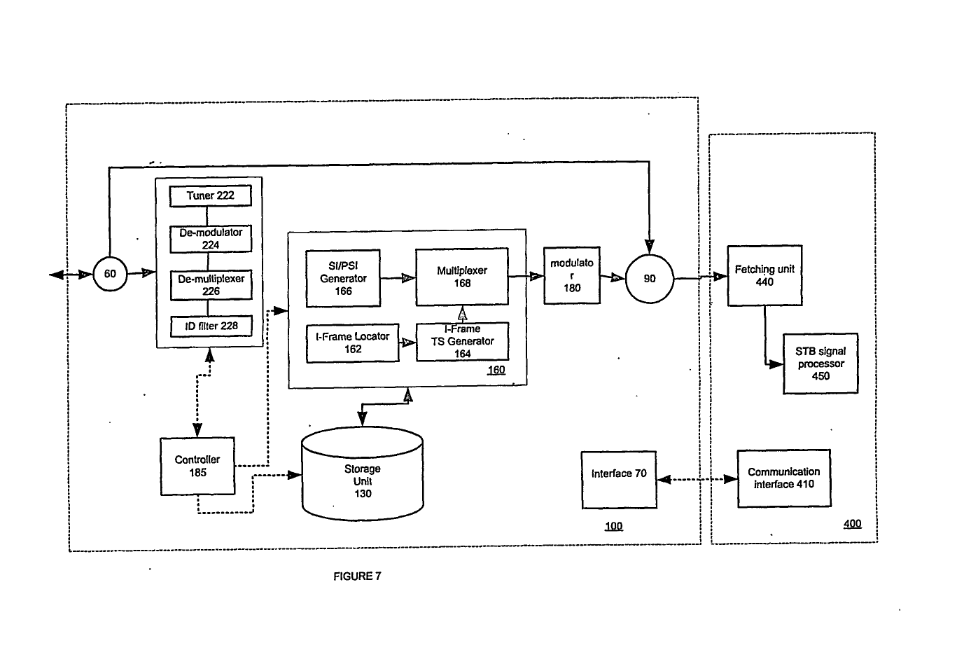

FIG. 6 illustrates three carrier frequencies F1-F3 501-503 and multiple programs PRI-PR20 510-530 and trick play mode programs TPR1-TPR10 540-550 that are conveyed over these carrier frequencies, according to an aspect of the invention. It is assumed that TPR1 originated from PR2 thus has the same Program ID as PR2 (- Program ID).

As can seen from this figure the trick play mode programs define a unique DVB network, while maintaining their original Program ID/service ID. The meta-data that is associated with each trick play mode program includes its PID as well as its carrier frequency. Accordingly, once an end user requests to review a certain trick play mode program (for example TRP 1 540) the tuner of his set top box 400 is tuned to F3 503 and his de-multiplexer sends the MPEG decoder media streams that are identified by PID2.

As mentioned above by associating the Program ID of the programs from which trick play mode programs originated, the management of conditional access as well as exchange of information with a service provider is simplified.

Typically, the local entity 100 or the set top boxes 400 send the service provider the meta-data relating to the trick play mode programs. This can be used for conditional access operations associated with the trick play mode programs, as well as to billing and the like.

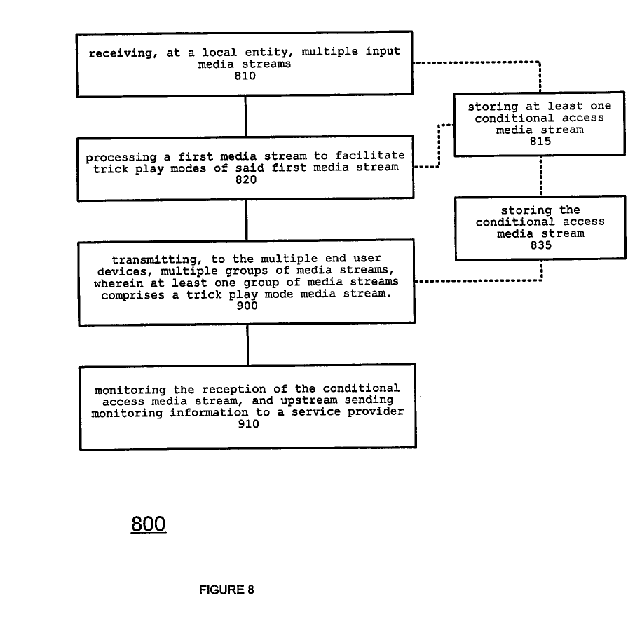

Referring now to FIG. 7 that illustrates in further detail various components of local entity 100, according to an embodiment of the invention. It is assumed that the local entity receives multiple transport streams that include a program 50 that an end user requested to record. The Program ID of that program is denoted Program ID_R. It is noted that various requests of an end user can be interpreted as a request to record said program. For example, when an end user requests to pause the display of a certain program the local entity can store that certain program to allow seamless viewing of that certain program. Pre tuning to enable quick response to Pause operation on live stream.

The tuner 222 of the fetching unit 220 is tuned to the carrier frequency of that program and the de-multiplexer 226 is adapted to fetch audio, video and ECM Transport Stream packets that are associated with PID_R and to stored then in storage unit 130.

The local entity 100 may receive a request to view a recorded program 50. The request is usually generated by an application out of applications 420 and transmitted over communication interface 410, communication link 200 and interface 70 to the controller 185. In response the trick play mode processor retrieves the stored program and send the stored program along with meta-data to the modulator 180 to be modulated and to be conveyed over a certain carrier frequency. The output of the modulator is connected to adder 90 that adds the output of the modulator 180 to the received input media streams. The local entity 100 sends the meta-data to the set top box 400 to allow the set top box to identify the program and display it properly. It is noted that a delayed program may be transmitted along with modified meta-data that reflect said delay. The modified meta-data may include timing information, such as DVB timing information and especially modified TOT and TDT tables. The content of these tables affect the clock of the set top box 400. The modified meta-data may include SI/PSI tables that are generated by SI/SPI generator 166.

Once the controller 185 determines to accept the request the trick play mode processor 160 fetches the stored program 50 and process it to provide the requested trick play mode stream. Those of skill in the art will appreciate that various meta-data including timing information shall be modified, to provide a valid trick play mode program. Processor 160 can apply any of the prior art trick play mode generation methods. For example, a method based upon locating I-frames and generating a stream that includes a sequence of I-frames may be implemented. The stream may include a sequence of originally consecutive I-frames, but this is not necessarily so. Typically, the speed of the requested trick play operation defines which I-frames are selected to form the trick play mode stream.

An I-Frame locator 162 locates the I-frames of the stored program and can also locate associated ECM information. This can be executed when a trick play mode is requested or even “off line”. I-frames may be located by other entities and their location can be transmitted along with the programs. The I-frames can be transmitted without being encrypted to allow their detection even within an encrypted program. Locating I-frames can involve processing timing fields such as DTS and PTS, locating The location of the I-frames and optionally the location of associated ECM are fed to the I-Frame time stamp (TS) generator 164 that retrieves timing information associated with these I-frames, and generates media streams that are fed to a multiplexer 168. The multiplexer multiplexes the receives streams with updated meta data such as updated SI/PSI tables that are provided by an SI/PSI generator 166.

The local entity 100 is capable of reconstructing timing information even when a section of a program is encrypted. This may involve using other non-encrypted fields such as PCR filed to reconstruct the timing of the media streams. For example, the PCR in the Transport Stream packet header determines the time (in 27 Mhz clock) between a range of packets. This information can be utilized to determine the bit-rate of a certain program.

According to an aspect of the invention the multiplexer 160 is connected to the modulator 180 via a LVDS interface. LVDS transmission is characterized by a very low data swing, low noise and high reliability. Clock signals and information are sent together over the LVDS interface. Or/with memory buffer which allow writing data (multiplexer)and reading data (modulator) simultaneously.

FIG. 8 illustrates a method 800 for providing media streams from a local entity 100 to multiple end users devices, such as set top boxes 400. Method 800 starts by stage 810 of receiving, at local entity 100, multiple input media streams. Referring to FIG. 2 these input media streams may form multiple input programs and are provided by satellite dish 11.

Stage 810 is followed by stage 820 of processing a first media stream to facilitate trick play modes of said first media stream. Stage 820 may include generating and storing at least one trick play mode program but may also include generating only meta-data required to later generate a trick play mode program. The meta-data may include the locations of I-frames and the like. The first media stream may be selected in response to end user requests, in response to end user profile and the like.

Stage 820 is followed by stage 900 of transmitting, to the multiple end user devices, multiple groups of media streams, wherein at least one group of media streams comprises a trick play mode media stream. The transmission may be preceded by multiplexing a trick play media stream with input media streams and even replacing an input media stream by a trick play mode media stream. As illustrated by FIGS. 5A-5C, the stage of transmitting may include allocating a fixed carrier frequency for conveying the trick play mode media stream. The stage of allocating can be followed by a stage of generating the carrier frequency by a phase locked loop circuit. According to another aspect of the invention the stage of allocating is followed by a stage of generating the carrier frequency by a phase locked loop circuit.

It is noted that the stage of transmitting may include transmitting media streams over a link that is coupled to means for providing the multiple input media streams. Such a scenario is illustrated at FIG. 1. The transmission stage may involve preventing the trick play media stream to propagate to the means for providing the multiple input media streams.

The method 800 is also adapted to handle conditional access media streams, For example, stage 810 may be followed by stage 815 of storing at least one conditional access media stream.

Stage 815 may be followed by stage 820 of processing the conditional access media stream or may be followed by stage 835 of storing the conditional access media stream. Stage 900 may include transmitting said conditional access media stream if a conditional access criterion is fulfilled. The criterion may be time dependent and may include paying a fee, registration of the provision of the conditional access stream to the end user device, and the like. A time dependent criterion may depend upon the timing of the recording of the conditional access media stream and the timing of a request to view the media stream. If, for example a service provider allows all its subscribers to view a certain conditional access channel for free, during a certain time period then requests to store the programs that were transmitted during that time period may be approved even if they are initialized after the time period expires. This is not necessarily so and such requests can be denied.

Stage 900 may be followed by stage 910 of monitoring the reception of the conditional access media Stream, and upstream sending mionitoring information to a service provider.

It is further noted that in the case that if two end user devices require to receive different trick play mode media streams originates from the same input media stream this may require either allocating different carrier frequencies to said trick play mode media streams or altering the identification information associated with at least one of said media streams.

According to an embodiment of the invention the stage of transmitting comprises allocating a variable carrier frequency for conveying the trick play mode media stream. The carrier frequency is variable in the sense that a certain frequency can be allocated at a certain moment to a certain trick play mode program sent to a certain end user device while another frequency can be allocated at another moment an/or to another end user device and/or to another trick play mode program.

According to an embodiment of the invention the allocation of carrier frequency can be responsive to bandwidth constrains, such as available carrier frequencies, bandwidth utilized for conveying programs to end users, and the like

The figures described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1-64. (canceled)

65. A method for providing media streams from a local entity to multiple end users devices the method comprising the stages of:
receiving, at a local entity multiple input media streams;
processing a first media stream to facilitate trick play modes of said first media stream; and
transmitting, to the multiple end user devices, multiple groups of media streams, wherein at least one group of media streams comprises a trick play mode media stream.

66. The method according to claim 65 wherein the stage of transmitting is preceded by a stage of generating the trick play mode media stream by the local entity.

67. The method according to claim 66 wherein the stage of generating is responsive to a request from the end user device.

68. The method according to claim 66 wherein the stage of transmitting is preceded by a stage of replacing an input media stream by the trick play mode media stream.

69. The method according to claim 65 wherein the stage of processing comprises fetching the first media stream out of the multiple input media streams.

70. The method according to claim 65 wherein the stage of transmitting comprises allocating a fixed carrier frequency for conveying the trick play mode media stream.

71. The method according to claim 70 wherein the stage of allocating is followed by a stage of generating the carrier frequency by a phase locked loop circuit.

72. The method according to claim 65 wherein the stage of transmitting comprises allocating a carrier frequency for conveying trick play mode media stream in response to an input media stream associated with the trick play mode media stream.

73. The method according to claim 72 wherein the stage of allocating is followed by a stage of generating the carrier frequency by a phase locked loop circuit.

74. The method according to claim 65 wherein the stage of transmitting comprises transmitting media streams over an link that is coupled to means for providing the multiple input media streams.

75. A local entity comprising:
a fetching unit adapted to receive multiple input media streams;
a processor for processing a first media stream to facilitate trick play modes of said first media stream; and
a transmitter, for transmitting to the multiple end user devices multiple groups of media streams, wherein at least one group of media streams comprises a trick play mode media stream.

76. The local entity according to claim 75 wherein the processor processes the first media stream in response to a request from the end user device.

77. The local entity of claim 75 further adapted to replace an input media streaniby the trick play mode media stream.

78. The local entity according to claim 75 wherein the fetching unit is adapted to fetch the first media stream out of the multiple input media streams.

79. The local entity according to claim 75 wherein the transmitter is adapted to allocate a fixed carrier frequency for conveying the trick play mode media stream.

80. The local entity according to claim 75 wherein the transmitted comprises a phase locked loop for generating the carrier frequency.

81. The local entity according to claim 75 wherein the transmitted is adapted to allocate a carrier frequency for conveying trick play mode media stream in response to an input media stream associated with the trick play mode media stream.

82. The local entity according to claim 75 wherein the transmitter is coupled to a link that is coupled to means for providing the multiple input media streams.

83. The local entity according to claim 82 further comprising a filter for preventing the trick play media stream to propagate to the means for providing the multiple input media streams.

84. The local entity according to claim 75 whereas the local entity has a storage unit adapted to store at least one conditional access media stream.
